(19) United States
(12) Patent Application Publication
(10) Pub. No.: US 2015/0117993 A1
(43) Pub. Date: Apr. 30, 2015

(54) AUTOMATED WORKPIECE LOADING/UNLOADING DEVICE

(71) Applicants: FU DING ELECTRONICAL TECHNOLOGY (JIASHAN) CO.,LTD., Zhejiang (CN); HON HAI PRECISION INDUSTRY CO., LTD., New Taipei (TW)

(72) Inventors: MING-LU YANG, New Taipei (TW); YA-DONG ZHANG, Jiashan (CN); YONG ZHAO, Jiashan (CN)

(21) Appl. No.: 14/510,333

(22) Filed: Oct. 9, 2014

(30) Foreign Application Priority Data
Oct. 24, 2013 (CN) 201320656501.6

(51) Int. Cl. B65G 1/10; B65G 1/02

(52) U.S. Cl. CPC B65G 1/10; B65G 1/026
USPC 414/331.17

(57) ABSTRACT

An automated workpiece loading/unloading device comprises a housing, an electrical box, a workpiece driving device, an elevating mechanism, and a workpiece holding device. The elevating mechanism comprises a movable platform. The workpiece holding device can be assembled to the movable platform and configured to hold a plurality of workpieces. The workpiece holding device can vertically move by the driving of the elevating mechanism. The workpieces can be collected in the workpiece holding device, or released from the workpiece holding device driven by the workpiece driving device.

### FIELD

The subject matter herein generally relates to automated workpiece loading/unloading devices, and particularly to automated workpiece loading/unloading devices for use in automated production lines.

### BACKGROUND

More automated workpiece loading/unloading devices are employed in automated production lines, particularly in the assembly industry, the products or workpieces usually need to be transferred to a designated place by a conveyor belt.

### BRIEF DESCRIPTION OF THE DRAWINGS

Implementations of the present technology will now be described, by way of example only, with reference to the attached figures.

FIG. 1 is a perspective view of an embodiment of an automated workpiece loading/unloading device.

FIG. 2 is an exploded, perspective view of a portion of the automated workpiece loading/unloading device of FIG. 1.

FIG. 3 is a perspective view of an elevating mechanism of the automated workpiece loading/unloading device of the FIG. 1.

FIG. 4 is a perspective view of a workpiece holding device of the automated workpiece loading/unloading device of the FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to an automated workpiece loading/unloading device.

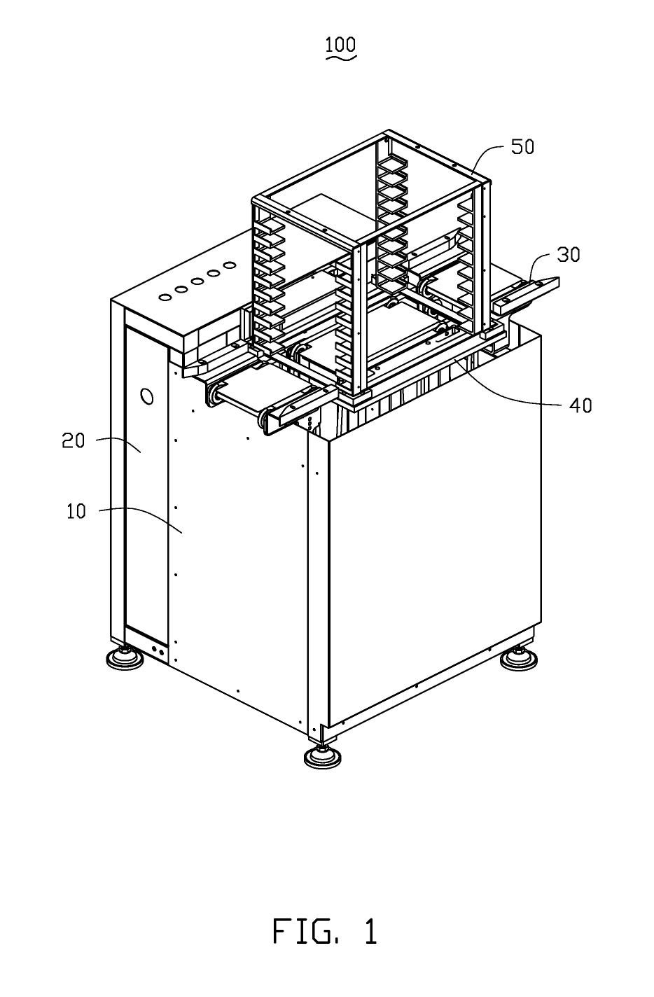

FIG. 1 illustrates an embodiment of an automated workpiece loading/unloading device 100. The automated workpiece loading/unloading device 100 can include a housing 10, an electrical box 20, a workpiece driving device 30; an elevating mechanism 40, and a workpiece holding device 50. The workpiece driving device 30 and the elevating mechanism 40 can be received in the housing 10. The workpiece holding device 50 can be assembled to the elevating mechanism 40. The workpiece driving device 30 and the elevating mechanism 40 can be electrically connected to the electrical box 20, and the electrical box 20 can control the workpiece driving device 30 and the elevating mechanism 40.

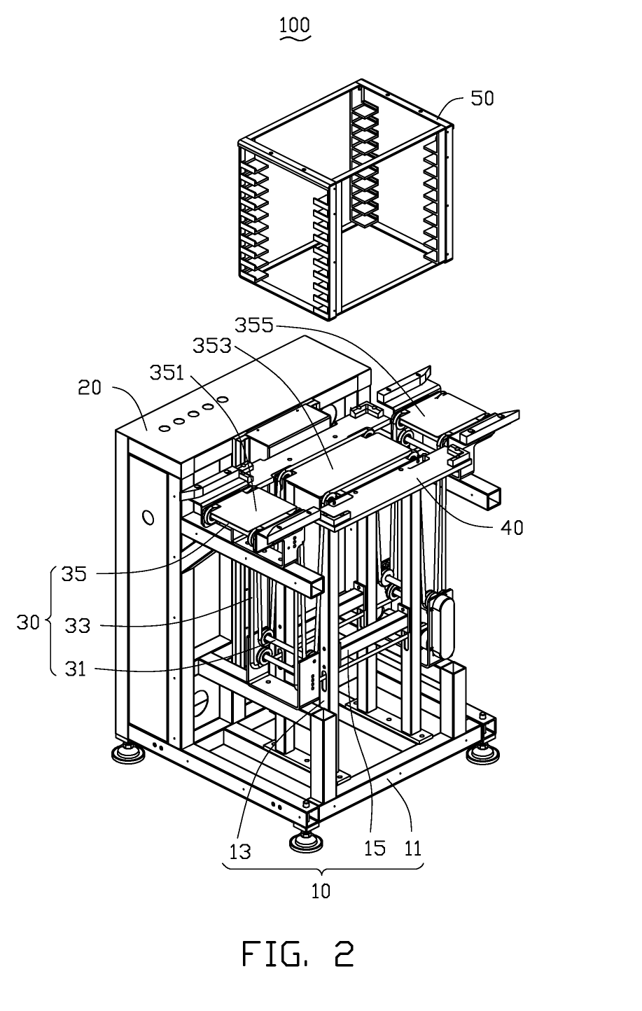

FIG. 2 illustrates an exploded, perspective view of a portion of the automated workpiece loading/unloading device 100. The housing 10 can include a main body 11, a supporting bracket 13, and a fixing bracket 15. The supporting bracket 13 can be positioned in the main body 11, and is configured to attach the workpiece driving device 30 and the elevating mechanism 40. The fixing bracket 15 can be located on the supporting bracket 13, and is configured to limit a movement of the elevating mechanism 40.

The electrical box 20 can be assembled to one side of the main body 11, and includes a plurality of electronic elements, such as a power supply, inductance, etc.

The workpiece driving device 30 can be configured to convey the workpieces, and includes a plurality of driving portions 31, a plurality of belts 33, and a plurality of supporting plates 35. The plurality of driving portions 31 can be assembled to the supporting bracket 13, and each driving portion 31 can include a transmission shaft and a driving wheel. Each belt 33 can be coupled to the corresponding driving wheel of the driving portion 31, and the belt 33 can be driven by the driving portion 31. Each supporting plate 35 can be positioned between two parallel belts 33, and include a first supporting plate 351, a second supporting plate 353, and a third supporting plate 355 respectively configured to support the workpieces. In operation, the workpieces can be conveyed from the first supporting plate 351 to the second supporting plate 353, then, the workpieces positioned on the second supporting plate 353 can be conveyed to the third supporting plate 355.

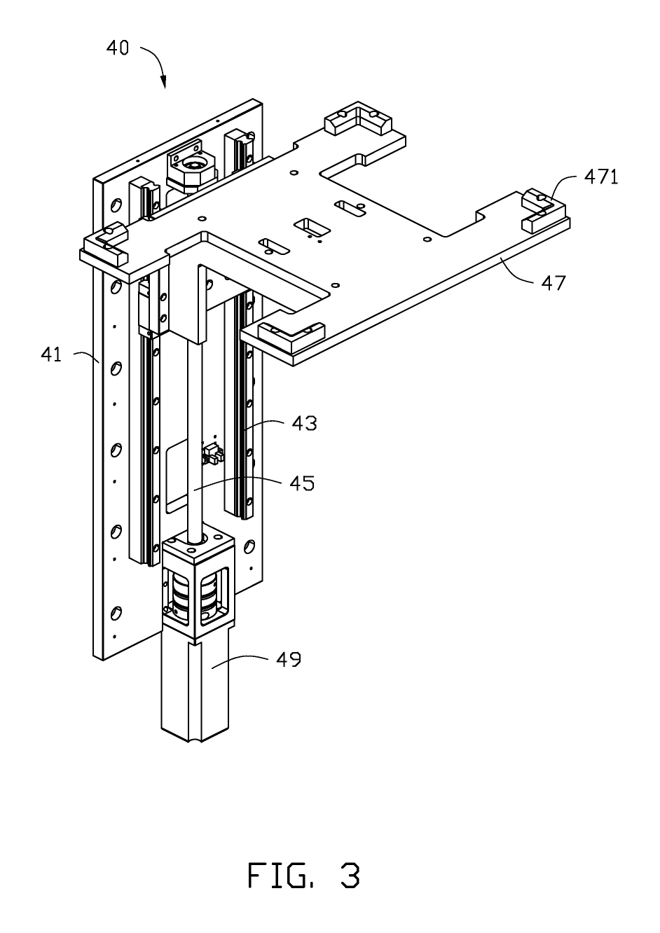

FIG. 3 illustrates a perspective view of the elevating mechanism 40. The elevating mechanism 40 can drive the workpieces vertically. The elevating mechanism 40 can include a vertical fixing plate 41, two slide guides 43, a screw rod 45; a movable platform 47, and a motor 49. The fixing plate 41 can be assembled to the housing 10, and the two slide guides 43 can be assembled to the fixing plate 41 in parallel. The movable platform 47 can be substantially rectangular, and slidable along the two slide guides 43. The screw rod 45 can be positioned between the two slide guides 43, and parallel to the slide guide 43. The motor 49 can be coupled to one end of the screw rod 45 to drive the screw rod 45 to revolve on its own axis.

The movable platform 47 can include a plurality of positioning parts 471 configured to fasten the workpiece holding device 50. In the illustrated embodiment, the plurality of positioning parts 471 can be four, and can be respectively assembled to corners of the rectangular movable platform 47. In operation, the movable platform 47 can move between the fixing bracket 15 and the second supporting plate 353, and the movable platform 47 can be placed below the second supporting plate 353 (shown in FIG. 2).

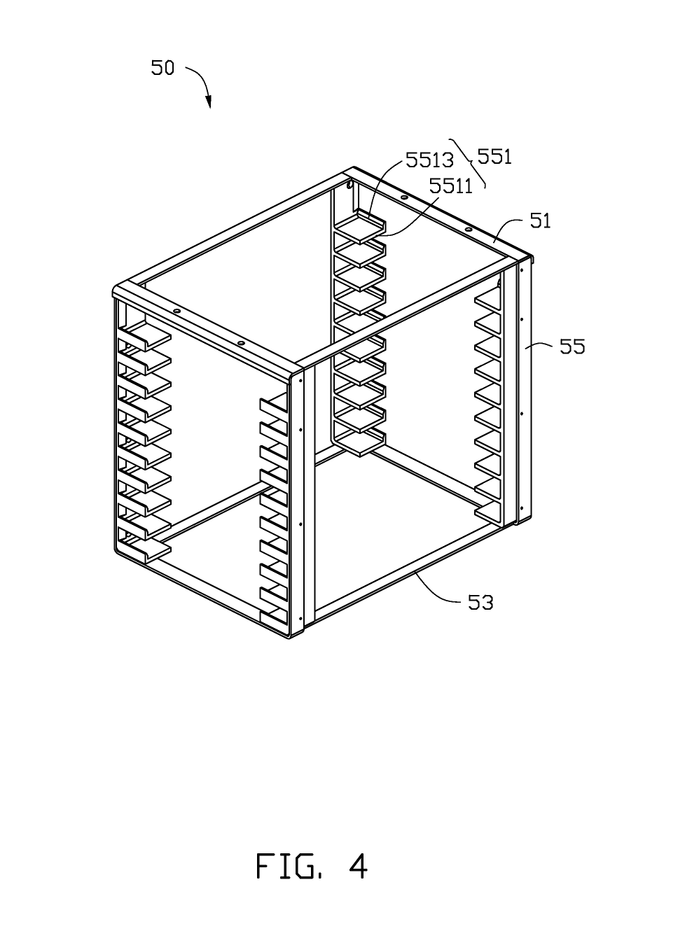

FIG. 4 illustrates a perspective view of the workpiece holding device 50. The workpiece holding device 50 can be assembled to the movable platform 47 (shown in FIG. 3), and configured to load the workpieces. The workpiece holding device 50 can be a substantially cubed, and include a first frame 51, a second frame 53, and a plurality of supporting arms 55 connected between the first frame 51 and the second frame 53. In the illustrated embodiment, the plurality of supporting arms 55 can be four. Each supporting arm 55 can define a plurality of trays 551 evenly distributed, and the plurality of trays 551 can be separated from each other. Each tray 551 can include a supporting portion 5511, and a holding portion 5513 perpendicular to the supporting portion 5511. The supporting portion 5511 can be configured to support the workpieces, and the holding portion 5513 can be configured to prevent the workpieces from falling from the trays 551.

In operation, the automated workpiece loading/unloading device 100 can collect the workpieces. The workpieces can be positioned on the first supporting plate 351 of the automated workpiece loading/unloading device 100. The elevating mechanism 40 can drive the workpiece holding device 50 to move vertically. The workpiece driving device 30 can convey the workpieces from the first supporting plate 351 to the second supporting plate 353. One workpiece can be precisely received in the trays 551, when the holding portion 5513 of the upper tray 551 is moved below the second supporting plate 353. The workpiece holding device 50 moves up, the other workpieces can be received in the corresponding trays 551 in turn. An operator can manually remove the workpiece holding device 50 from the automated workpiece loading/unloading device 100, and fill in a new empty workpiece holding device 50. When a sensor senses that the workpiece holding device 50 is full.

FIG. 2 and FIG. 4 illustrate that the automated workpiece loading/unloading device 100 can also release the workpieces. The automated workpiece loading/unloading device 100 can be positioned on a head of an automated production line. The workpiece can drop into the supporting plate 353, when the lower trays 551 move below the second supporting plate 35. The workpiece driving device 30 can convey the workpieces from the second supporting plate 353 to the third supporting plate 355. The workpiece holding device 50 continuously moves down, other workpieces can drop from the trays 551 into the supporting plate 353 in turn. An operator can manually remove the workpiece holding device 50 from the automated workpiece loading/unloading device 100, and replace a new workpiece holding device 50 filled with workpieces. A sensor senses that no more workpieces are in the workpiece holding device 50.

The automated workpiece loading/unloading device 100 can be positioned between automated production lines, and can properly load or unload some workpieces. Therefore the automated workpiece loading/unloading device 100 can ensure a normal density of the workpieces positioned on the automated production line.

In the illustrated embodiment, at least a portion of the workpiece driving device 30 can move workpieces in a first direction. The workpiece holding device 50 can be movable in a loading direction and an unloading direction with the unloading direction opposite of, and parallel to, the loading direction, and with the loading direction and unloading direction each being substantially perpendicular to the first direction. The workpiece driving device 30 can load workpieces onto the workpiece holding device 50 when the workpiece holding device 50 moves in the loading direction and unloads workpieces when moves in the unloading direction.

The automated workpiece loading/unloading device 100 can have a simple construction and a high production efficiency. The automated workpiece loading/unloading device 100 can also realize an automatic process for loading/unloading the workpieces.

The embodiments shown and described above are only examples. Many details are often found in the art such as the other features of an automated workpiece loading/unloading device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An automated workpiece loading/unloading device comprising:
a workpiece driving device;
an elevating mechanism having a movable platform; and
a workpiece holding device positionable on the movable platform, the workpiece holding device is able to hold a plurality of workpieces;
wherein, at least a portion of the workpiece driving device moves workpieces in a first direction;
wherein, the workpiece holding device is movable in a loading direction and an unloading direction with the unloading direction opposite of, and parallel to, the loading direction, and with the loading direction and unloading direction each being substantially perpendicular to the first direction; and
wherein, the workpiece driving device loads workpieces onto the workpiece holding device when the workpiece holding device moves in the loading direction and unloads workpieces when moves in the unloading direction.

2. The automated workpiece loading/unloading device as claimed in claim 1, wherein the automated workpiece loading/unloading device further comprises a housing, the housing comprises a main body, a supporting bracket, and a fixing bracket, the supporting bracket is positioned in the main body, and the fixing bracket is located on the supporting bracket.

3. The automated workpiece loading/unloading device as claimed in claim 2, wherein the workpiece driving device comprises a plurality of driving portions and a plurality of belts, the plurality of driving portions are assembled to the supporting bracket, and each belt is coupled to the corresponding driving portions.

4. The automated workpiece loading/unloading device as claimed in claim 3, wherein the workpiece driving device also comprises a plurality of supporting plates, each supporting plate is positioned between the two parallel belts.

5. The automated workpiece loading/unloading device as claimed in claim 4, wherein the plurality of supporting plates comprises a first supporting plate, a second supporting plate, and a third supporting plate, and the movable platform are placed below the second supporting plate.

6. The automated workpiece loading/unloading device as claimed in claim 5, wherein the movable platform define a plurality of positioning parts configured to fasten the workpiece holding device.

7. The automated workpiece loading/unloading device as claimed in claim 1, wherein the elevating mechanism comprises a fixing plate and two slide guides, the two slide guides are assembled to the fixing plate in parallel, and the movable platform is slidable along the two slide guides.

8. The automated workpiece loading/unloading device as claimed in claim 7, wherein the elevating mechanism further comprises a screw rod and a motor, the screw rod is positioned between the two slide guides, and parallel to each slide guide.

9. The automated workpiece loading/unloading device as claimed in claim 8, wherein the motor is coupled to one end of the screw rod to drive the screw rod to revolve on its own axis.

10. The automated workpiece loading/unloading device as claimed in claim 1, wherein the workpiece holding device comprises a first frame, a second frame, and a plurality of supporting arms connected between the first frame and the second frame.

11. The automated workpiece loading/unloading device as claimed in claim 10, wherein each supporting arm defines a plurality of trays evenly distributed.

12. The automated workpiece loading/unloading device as claimed in claim 11, wherein each tray comprises a supporting portion and a holding portion perpendicular to the supporting portion, the supporting portion supports the workpieces, and the holding portion prevents the workpieces from falling from the trays.

13. The automated workpiece loading/unloading device as claimed in claim 1, wherein the automated workpiece loading/unloading device further comprises an electrical box, the workpiece driving device and the elevating mechanism are electrically connected to the electrical box.

14. The automated workpiece loading/unloading device as claimed in claim 13, wherein the electrical box controls the workpiece driving device and the elevating mechanism.
